(19) United States
(12) Patent Application Publication
(10) Pub. No.: US 2008/0281938 A1
(43) Pub. Date: Nov. 13, 2008

(54) Selecting a master node in a multi-node computer system

(75) Inventors: Vikram Rai, San Francisco, CA (US); Alok Srivastava, Newark, CA (US); Juan Tellez, Piedmont, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: Oracle International Corporation, Redwood Shores, CA (US)

(21) Appl. No.: 11/801,494

(22) Filed: May 9, 2007

(51) Int. Cl. G06F 15/16

(52) U.S. Cl. 709/209

(57) ABSTRACT

Selecting a master node in a multi-node computer system is described. Each node of the multi-node computer system selects a timeout value (e.g., randomly). Each node starts a timer, which is set to expire at the selected timeout value of its corresponding node. The node with the timer that expires earliest broadcasts an election message to the other nodes of the multi-node computer system, which informs the other nodes that the broadcasting node is a candidate for mastership over the multi-node computer system. The other nodes respond to the election message upon receiving it. In the absence of a refusal message from one or more of the other nodes, the candidate is established as master node in the multi-node computer system and wherein the other nodes function as slave nodes therein.

The present invention relates generally to parallel and distributed computing. More specifically, embodiments of the present invention relate to selecting a master node in a computer system of multiple nodes.

### BACKGROUND

Networked systems of multiple computers such as clusters allow parallel and distributed computing. A cluster is a multi-node computer system, in which each node comprises a computer, which may be a server blade. Clusters function as collectively operational groups of servers. The nodes, also called members, of a cluster or other multi-node computer system function together to achieve high server system performance, availability and reliability. For clusters and other multi-node computer systems to function properly, time and access to shared resources is synchronized between its nodes. In a clustered database system for instance, time synchronicity between members can be significant in maintaining transactional consistency and data coherence.

For instance, such distributed computing applications have critical files that need to be circulated on all servers of the cluster. Any server of the cluster may be a master node therein, which may have newer versions of the critical files. Time synchronization of all servers in the cluster allows timestamps associated with files to be compared, which allows the most current (e.g., updated) versions thereof to be distributed at the time of file synchronization. Moreover, the high volume and significance of tasks that are executed with network-based applications demands a reliable cluster time synchronization mechanism.

To achieve time synchronism between cluster members, the clock of one or more cluster members may be adjusted with respect to a time reference. In the absence of an external time source such as a radio based clock or a global timeserver, computer based master election processes select a reference “master” clock for cluster time synchronization. A master election process selects a cluster member as a master and sets a clock associated locally with the selected member as a master clock. The clocks of the other cluster members are synchronized as “slaves” to the master reference clock. Thus, a master election process essentially selects a coordinating process, based in a “master” node, in a cluster and/or parallel and distributed computing environments similar thereto.

Master selection by conventional means can have arbitrary results or rely on an external functionality. For instance, one typical master selection algorithm simply chooses a node having a lowest identifier or time in the cluster to be master. Other master selection techniques involve an external management entity, such as a cluster manager, to arbitrarily or through some other criteria select a master. These algorithms and managers may suffer inefficiencies, as where a node selected therewith as master has either a slow running or a renegade (e.g., excessively fast-running) clock associated therewith.

Master election processes however require a reliable algorithm to determine which process or machine is entitled to master status in a cluster. Where a machine or a process running on a node deserves master status based on the node being the first node to join or function in a cluster, conventional processes may face cold-start or “chicken & egg” issues, which can complicate or deter effective master selection. Such difficulties may be exacerbated with computer clusters that span multiple network environments. This is because it is not possible to predict which machines in a multi-network cluster will become unavailable due to failures, being taken off-line or deenergized, reset, rebooted or the like.

Pre-established switchover hierarchies, which are typically used with primary/secondary server scenarios and the like, are impractical with clusters and other such parallel and distributed computing environments. Single coordinators for master selection, while simple, lack usefulness with mission-critical distributed applications because a failure of the single coordinator could result in total failure of the cluster network.

Based on the foregoing, a reliable master election process for clusters and other parallel and distributed computing environments that is independent of dedicated management systems or arbitrary processes would be useful.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example multi-node computer system, with which an embodiment of the present invention may be used;

FIG. 2 depicts an example process for selecting a master node in a cluster, according to an embodiment of the invention;

FIG. 3 depicts an example cluster services system, according to an embodiment of the invention; and

FIG. 4 depicts an example computer system platform, with which an embodiment of the present invention may be practiced.

### DESCRIPTION OF EXAMPLE EMBODIMENTS

Selecting a master node in a computer system of multiple nodes is described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily obscuring the present invention.

### OVERVIEW

Example embodiments herein relate to selecting a master node in a computer system of multiple nodes such as a cluster or other parallel or distributed computing environments. Each node of the multiple node (multi-node) computer system selects a timeout value (e.g., randomly). Each node starts a timer, which is set to expire at the selected timeout value of its corresponding node. The node with the timer that expires earliest broadcasts an election message to the other nodes of the multi-node computer system, which informs the other nodes that the broadcasting node is a candidate for mastership over the multi-node computer system. The other nodes respond to the election message upon receiving it. In the absence of a refusal message from one or more of the other nodes, the candidate functions as master node in the multi-node computer system and wherein the other nodes function as slave nodes therein.

The example embodiments described thus achieve a reliable, essentially failsafe process for selecting a master in a cluster and similar distributed and parallel computing applications.

Multi-node computer systems are described herein by way of illustration (and not limitation) with reference to an example computer cluster embodiment. Embodiments of the present invention are well suited to function with clusters and other computer systems of multiple nodes.

### EXAMPLE COMPUTER CLUSTER

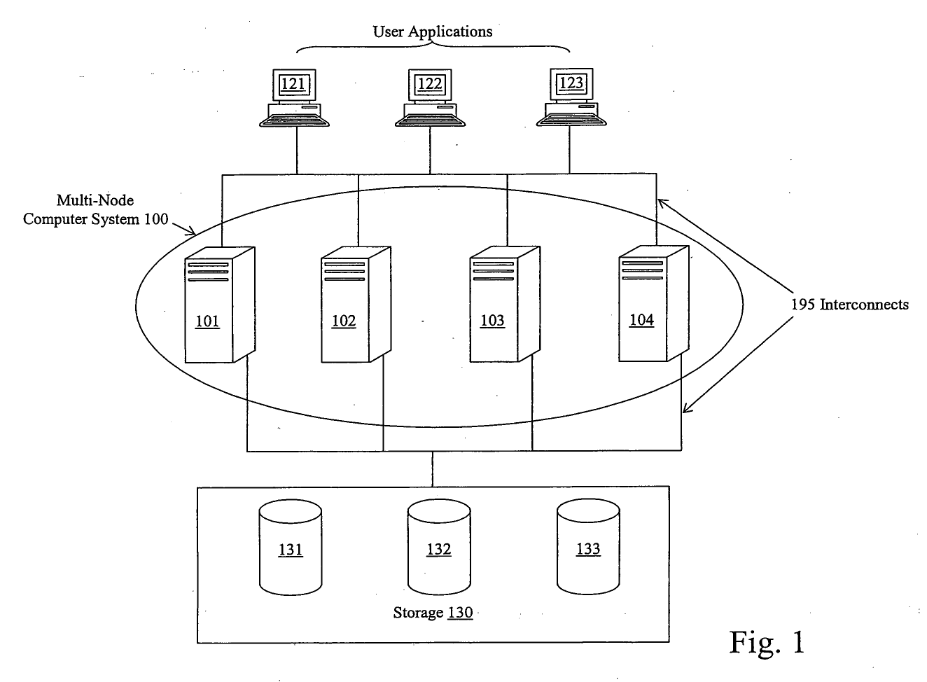

FIG. 1 depicts an example computer multi-node computer system 100, according to an embodiment of the present invention. In an embodiment, multi-node computer system 100 functions as a computer cluster, with which embodiments of the present invention are illustrated. It is appreciated that in various embodiments, multi-node computer system 100, while illustrated & explained with reference to a cluster, may be any kind of multiple node, parallel and/or distributed computer system. Multi-node computer system 100 comprises computers 101, 102, 103 and 104, which are interconnected to support multiple distributed applications 121, 122 and 123.

One of the computers 101-104 of multi-node computer system 100 functions as a master node and the others function as slave nodes. A master node functions as a master for one or more particular functions, such as time synchronization among all nodes of the multi-node computer system. However, a master node in the multi-node computer system may also run applications in which there are other master-slave relations and/or in which there are no such relations. While any one of the computers 101-104 can function as a master node of multi-node computer system 100, only one of them may be master at a given time. Further, while four computers are shown for simplified illustration and description, virtually any number of computers can be interconnected as nodes of multi-node computer system 100 and an implementation with a larger number is specifically contemplated. Nodes of the clusters, including slaves and masters, exchange messages with each other to achieve various functions.

For instance, messages are exchanged, among other things, for time synchrony within the cluster. Each of the nodes 101-104 has a clock associated therewith that keeps a local time associated with that node. Such a clock may be implemented in the hardware of each computer, for example with an electronic oscillator. The clock associated with the master node essentially functions in some respects as a master clock for multi-node computer system 100. Clocks of the slave nodes may be synchronized periodically with the clock of the master. Cluster clock synchrony is achieved with slave nodes sending synchronization request messages to the master node and the master responding to each request message with a master clock time report related synchronization reply message. Inter-node cluster messages thus illustrated are exchanged for a variety of reasons in addition to achieving and/or maintaining synchrony.

The computers 101-104 of multi-node computer system 100 are networked with interconnects 195, which can comprise a hub and switching fabric, a network, which can include one or more of a local area network (LAN), a wide area network (WAN), an internetwork (which can include the Internet), and wire line based and/or wireless transmission media. In an embodiment, interconnects 195 inter-couple one or more of the nodes in a LAN.

Computers 101-104 may be configured as clustered database servers. So configured, cluster 100 can implement a real application cluster (RAC), such as are available commercially from Oracle™ Corp., a corporation in Redwood Shores, Calif. Such RAC clustered database servers can implement a foundation for enterprise grid computing and/or other solutions capable of high availability, reliability, flexibility and/or scalability. The example RAC 100 is depicted by way of illustration and not limitation.

Multi-node computer system 100 interconnects the distributed applications 121-122 to information storage 130, which includes example volumes 131, 132 and 133. Storage 130 can include any number of volumes. Storage 130 can be implemented as a storage area network (SAN), a network area storage (NAS) and/or another storage modality.

In an embodiment, multi-node computer system 100 interoperates the nodes 101-104 together over interconnects 195 with one or more of a fast messaging service, a distributed lock service, a group membership service and a synchronizing service.

### EXAMPLE PROCESS FOR SELECTING A MASTER NODE IN A MULTI-NODE SYSTEM

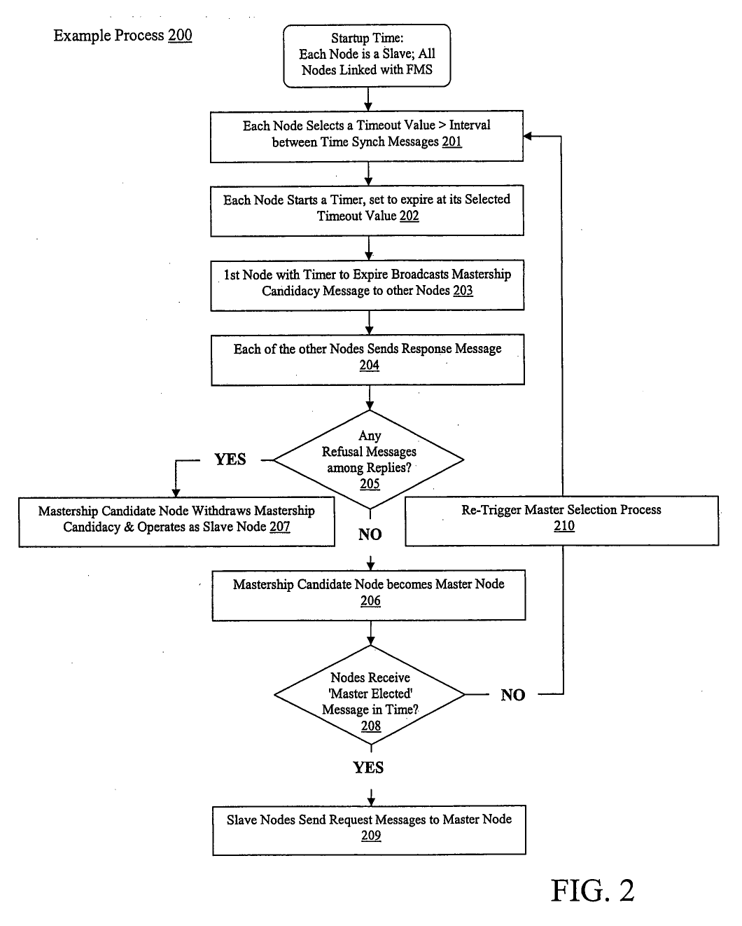

FIG. 2 depicts an example procedure 200 for selecting a master node in a multi-node computer system, according to an embodiment of the invention. Procedure 200 functions to select a master node in a multi-node computer system (e.g., multi-node computer system 100; FIG. 1) such as a cluster. At startup time of procedure 200, each node of the multi-node computer system is a slave node (e.g., functions in a slave mode) and all of the nodes are linked (e.g., communicatively inter-coupled) with a fast message service (FMS).

In an embodiment, the fast membership service comprises an Ethernet based messaging system that substantially complies with the IEEE 802.3 standard of the Institute for Electrical and Electronic Engineers, which defines the CSMA/CD protocol (Carrier Sense, Multiple Access with Collision Detection). Features of the fast message system include that only one member node coupled therewith can broadcast a message at any given time and thus, that messages are received therein in the order in which the messages were sent. The fast message service allows the nodes to exchange time synchronizing messages and election messages. When time synchronizing messages are exchanged within the multi-node computer system, a time interval separates a synchronizing request message from a slave node and a reply message from the master node, responsive thereto. Embodiments of the present invention are described below with reference to several example scenarios that relate to clustered computing, and which may provide contexts in which procedure 200 may function.

Example: Nodes Joining an Existing Cluster

In an embodiment, procedure 200 is triggered upon one or more nodes joining a cluster, in which no master node is readily apparent, e.g., no master node currently exists and/or the nodes are unable to ascertain which of the joining nodes is the first to join the cluster. Upon one or more nodes joining an existing cluster of nodes, in which a master node is functionally apparent, present, operational, etc., procedure 200 does not have to be triggered. Essentially, nodes joining an existing cluster with a functional master node are apprised of the identity, address and communicative availability, etc. of the master node and begins exchanging messages therewith as needed and essentially immediately. In an embodiment, a node joining an existing cluster with a functional master node thus receives information relating to an existing functional master node by a group membership service of the cluster, which notices the new node joining the cluster.

However, upon a new node joining a cluster and an application detecting a condition that signifies that a new master node should be elected for the cluster, procedure 200 may be triggered. For instance, upon a node joining a cluster, a cluster time synchronizing application, process or the like may notice that a joining node has a clock that is askew with respect to the cluster time, master clock time, etc.

In an embodiment, where the clock time of the newly joining node is ahead of the master clock time within an acceptable degree of precession, such as one or two standard deviations or other statistically determined criteria (e.g., the joining node's clock is not renegade, with respect to the cluster time), the newly joining node (or a functionality of the cluster itself) may re-trigger procedure 200. In an embodiment, the newly joining node thus contends to be master of the node. Where the new mastership candidate successfully assumes master functions in the cluster, subsequent time synchronization messages between the new master and the slaves of the cluster allow the slave clocks to be incrementally advanced to match the clock time of the new master node. Such synchronizing processes may comprise one or more techniques, procedures and processes that are described in co-pending U.S. patent application Ser. No. 11/698,605 filed on Jan. 25, 2007 by Vikram Rai and Alok Srivastava entitled SYNCHRONIZING CLUSTER TIME, which is hereby incorporated by reference in its entirety for all purposes as if fully set forth herein.

Example Flow for Master Selection Procedure

In block 201, each of the nodes selects a timeout value that is greater than the interval between time synchronizing messages that are exchanged over the fast message service. In an embodiment, the selection of a timeout value by each node is a random function; each node randomly selects its respective timeout value.

In block 202, each node starts a timer, which is set to expire at its selected timeout value. In block 203, the first node with a timer that expires (the node whose timer expires earliest) broadcasts an election message, which announces the broadcasting node's candidacy for mastership, to the other nodes over the fast message service. The fast message service allows only a single member node of the multi-node computer system to broadcast messages at a time.

Upon receiving the election message, each of the other nodes responds thereto in block 203 with a reply message, each of which are each sent to the mastership candidate node. In block 205, it is determined whether, among the reply messages, a refusal message is received from any of the nodes to which the election message was broadcast.

Where no refusal message is received among the replies, in block 206 the candidate node becomes the master node in the multi-node computer system and broadcasts an appropriate acknowledgement of the acceptance reply messages, such as a ‘master elected’ message, to the other nodes. Thus, the reply messages comprise acceptance messages, with which the other member nodes of the multi-node computer system assent to the mastership of the candidate. However, where a refusal message is received among the replies, in block 207 the candidate node withdraws its candidacy for mastership and functions within the multi-node computer system as a slave. In an implementation, the candidate node assumes mastership after a pre-determined period of time following receipt of the last acceptance reply message.

In an embodiment, upon sending their response message in block 204, each node waits for a period of time for an acknowledgement thereof, such as a ‘master election’ message, from a new master node. For instance, in an embodiment, upon initiating functions as master in block 206, the new master node broadcasts the ‘master elected’ message to the other nodes of the cluster. In an embodiment however, the ‘master elected’ message should be received within a time interval shorter than the time before time synchronization or other periodic messages are exchanged between the nodes, the expiration of a timer or another such time interval, period or the like. Thus, in block 208, it is determined whether the ‘master selected’ message is received by the other nodes “in time,” in this sense.

Where it is determined that the ‘master elected’ message is in that sense received in time, then in block 209, slave nodes begin to send request messages to the new master node. Essentially normal, typical and/or routine message exchange traffic thus commences and transpires within the cluster between the slaves and the master, etc. However, if it is determined that the ‘master elected’ message is not received by the other nodes in time, then in block 210, a master selection procedure is re-triggered. Procedure 200 may re-commence with block 201 (or alternatively, block 202).

In the event that, in performing the functions described with blocks 201-203, two or more nodes simultaneously select the lowest timeout value, the other nodes may receive multiple election messages. However, as the fast message service only allows broadcasts from a single mode at a time and thus, for messages to be received in the order in which they are sent, one of the multiple election messages will be received by the other nodes before they receive any of the others. In an embodiment, the nodes that receive the election messages respond in block 204 with an acceptance reply message only to the first election message; the receiving nodes then respond with only refusal reply messages to the other election messages that they may subsequently receive.

The node that assumes mastership in the multi-node computer system begins to function in a master mode therein; the other nodes therein function as slave nodes. Thus in block 208, the slave nodes send request messages, e.g., for time synchronizing purposes, to the master node. In an embodiment, prior to sending their request messages to the master node, each slave node starts a timer. This timer is cancelled when a reply is received from the master to the sending node's request message.

In an embodiment, when a sending slave's timer expires prior to receiving a reply from the master to its request, whichever sending node's timer expires first (e.g., earliest in time) restarts the election process, e.g., with block 203. This feature promotes the persistence of the multi-node computer system in the event of the death of a master node (e.g., the master goes off-line, is deenergized, fails or suffers performance degradation) or its eviction from the multi-node computer system.

Example: Nodes Leaving a Cluster

Perhaps somewhat more noticeably with larger clusters, nodes may join and leave with a fair degree of regularity, whether periodically or otherwise. The occasion of one or more slave nodes leaving a cluster may be essentially unremarkable; the cluster persists and functions normally in those slave nodes' absence. However, where a master node leaves a cluster, procedure 200 is triggered in an embodiment of the present invention to select a new master node for the cluster.

Example: Cluster and Node Behavior Across Reboots

While comprised of multiple nodes, in a number of significant aspects, a cluster functions as an entity essentially in and of itself. Further, the nodes of a cluster comprise communicatively linked but essentially separate computing functionalities. Thus, it is not surprising that, both clusters themselves, and individual nodes thereof, may from time to time be subject to reboots and similar perturbations. Embodiments of the present invention are well suited to provide robust master selection functions across cluster and/or node reboots and when clusters and their nodes are subject to related or similar disturbances.

In an embodiment, information relating to a master node of a cluster may persist across a reboot of the cluster. For instance, one or more values and/or other information relating to the cluster may be stored in a repository associated with the cluster (and/or locally with individual nodes thereof). Persistent master information storage allows the cluster to resume functioning with the same master node, upon rebooting the cluster. Where persisting master information across the cluster reboot is not desired for whatever reason, then upon rebooting the cluster, procedure 200 is triggered to select a master node anew.

With respect to an embodiment, rebooting a slave node is essentially unremarkable; master election is not necessarily implicated therewith. Upon rebooting a slave node in an embodiment, the slave learns about an existing member from the other nodes. Alternatively, a slave may, upon re-booting, be re-informed as to the identity and communicative properties of an existing master from a group membership service associated with the cluster.

However, when a node functioning as master in a cluster reboots, procedure 200 is triggered and the surviving nodes thus elect a new master node from among themselves. Upon rebooting, the former master node may return to the cluster as a slave node, which is informed of a master that was elected in its absence, if such a master exists. As a slave, the former master may participate in election of a master node and may trigger master election.

Example: Nodes Missing a Message

From time to time within a cluster, one or more nodes may not timely receive a message. For instance, during the operation of a cluster, a communication may not reach one or more nodes. With reference again to FIG. 1 for instance, where one or more of the interconnects 195 fails, suffers performance degradation, shutdowns or otherwise becomes unavailable, one or more of the nodes 101-104 may be released from the cluster. In a cluster with multiple nodes, such situations are sometimes referred to as a “split brain scenario.” In a hypothetical cluster of 100 nodes, the failure of a network switch or another cluster interconnect component may split the cluster into two or more child clusters; for example, one child of 50 nodes, one child with 30 nodes and another child of 20 nodes. In split brain scenarios and some other situations, the ‘master elected’ message, sent by a newly elected master node in block 206 may not be timely received by one or more nodes. An embodiment of the present invention functions robustly in such a scenario.

For instance, upon the cluster split, the existing master node may be among the child cluster of 30 nodes. In this situation, the existing master node may remain the master node in the child cluster of 30 nodes. The child cluster of 50 nodes and the child cluster of 20 nodes may then each repeat procedure 200 to independently elect new master nodes to function within each of the child clusters.

In a situation in which no master is elected in a cluster, procedure 200 may be repeated until a master node is elected. Alternatively, a master node may be randomly selected and appointed, e.g., with a cluster manager, or another master election technique may be substituted (e.g., temporarily) until a master election process such as procedure 200, may be executed according to an embodiment described herein.

Upon sending their response message in block 204, each node waits for a period of time for an acknowledgement thereof, such as a ‘master elected’ message, from a new master node. However, an embodiment assures that a master node is effectively elected by re-triggering procedure 200 in the event that one or more nodes fails to timely receive the ‘master elected’ message. Upon passage of an established time period such as the expiration of a selected and/or predetermined timeout value following sending their response message in block 204 to a mastership candidacy broadcast, if the ‘master elected’ acknowledgment is not received by any node, etc., then one or more of the nodes that do not receive the acknowledgement re-trigger procedure 200.

In an embodiment, procedure 200 may be re-triggered at any time in response to one or more of: (1) a master node reboots; (2) cluster reboot with no master persistence set; (3) the death of a master or a master otherwise leaving a cluster; (4) an application (e.g., cluster time synchronization) explicitly requesting election of a master; or (5) one or more nodes unaware of election of a master in their cluster (e.g., due to un-received or untimely receipt of messages).

### EXAMPLE SYSTEM

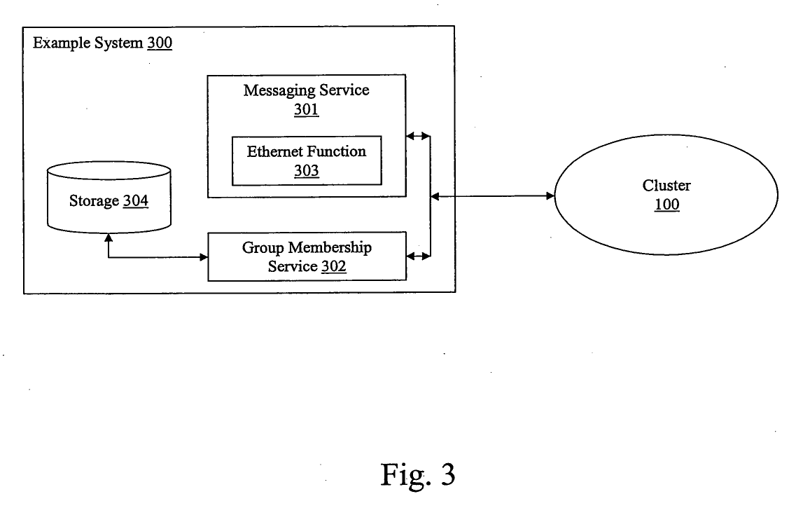

FIG. 3 depicts an example cluster services system 300, according to an embodiment of the invention. Cluster services system 300 may function with computer cluster 100 to facilitate a master election process such as process 200 (FIG. 2). In an embodiment, system 300 includes elements of a relational database management system (RDBMS). In an embodiment, system 300 is disposed or deployed with a cluster system.

In an embodiment, a function of cluster services system 300 is implemented with processing functions performed with one or more of computers 101-104 of cluster 100. In an embodiment, cluster services system 300 is configured with software that is stored with a computer readable medium and executed with processors of a computer system.

A messaging service 301 functions to allow messages to be exchanged between the nodes of cluster 100. Messaging service 301 provides a multipoint-to-point mechanism within cluster 100, with which processes running on one or more of the nodes 101-104 can communicate and share data. Messaging service 301 may write and read messages to and from message queues, which may have alternative states of persistence and/or the ability to migrate. In one implementation, upon failure of an active process, a standby process processes messages from the queues and the message source continues to communicate transparently with the same queue, essentially unaffected by the failure.

In an embodiment, messaging service 301 comprises a fast Ethernet based messaging system 303 that functions with a CSMA/CD protocol and substantially complies with standard IEEE 802.3. Features of the fast message service 303 include that only one member node coupled therewith can broadcast a message at any given time and thus, that messages are received therein in the order in which the messages were sent. The fast message service 303 allows the nodes to exchange election messages and time synchronizing messages. When messages, e.g., time synchronizing messages, are exchanged within the multi-node computer system, a time interval separates a synchronizing request message from a slave node and a reply message from the master node, responsive thereto.

A group membership service 302 functions with messaging service 301 and provides all node members of cluster 100 with cluster event notifications. Group membership service 302 may also provide membership information about the nodes of cluster 100 to applications running therewith. Subject to membership strictures or requirements that may be enforced with group membership service 302 or another mechanism, nodes may join and leave cluster 100 freely. Since nodes may thus join or leave cluster 100 at any time, the membership of cluster 100 may be dynamically changeable.

As the membership of cluster 100 changes, group membership service 302 informs the nodes of cluster 100 in relation to the changes. Group membership service 302 allows application processes to retrieve information about the membership of cluster 100 and its nodes. Messaging service 301 and/or group membership service 302 may be implemented with one or more Ethernet or other LAN functions.

In an embodiment, system 300 includes storage functionality 304 for storing information relating to member nodes of cluster 100. Moreover, storage 304 may store master information, to allow a master node to be persisted across cluster reboots. In another embodiment, such information may also or alternatively be stored in storage associated with cluster 100, such as storage 130, and/or stored locally with each node of the cluster.

In an embodiment, system 300 may also comprise other components, such as those that function for synchronizing time within cluster 100 and/or for coordinating access to shared data and controlling competition between processes, running in different nodes, for a shared resource.

### EXAMPLE COMPUTER SYSTEM PLATFORM

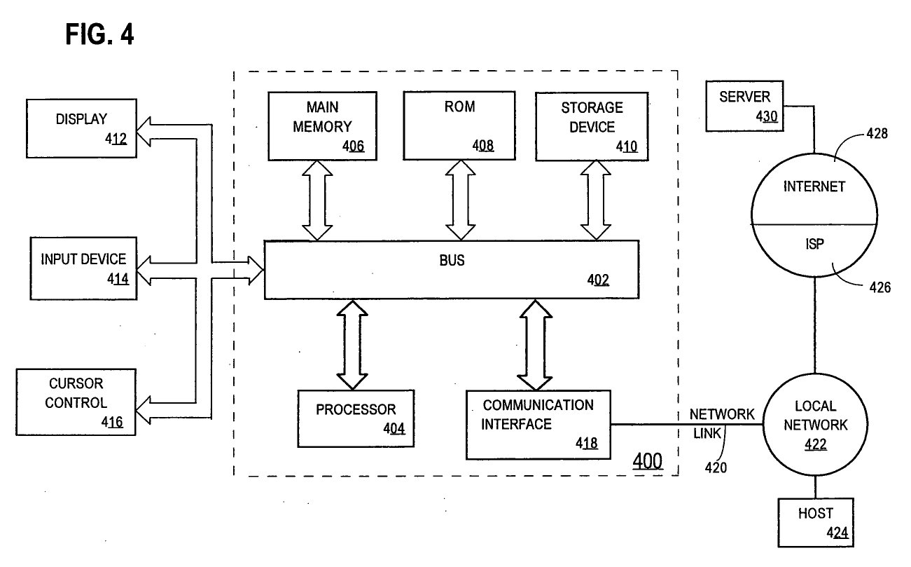

FIG. 4 is a block diagram that illustrates a computer system 400 upon which an embodiment of the invention may be implemented. Computer system 400 is descriptive of one or more nodes of a cluster and/or a system described herein such as system 300. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a liquid crystal display (LCD), cathode ray tube (CRT) or the like, for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for selecting a master node in a cluster. According to one embodiment of the invention, cluster master node selection is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card a digital subscriber line (DSL) or cable modem (modulator/demodulator) or the like to provide a data communication connection to a corresponding type of telephone line or another communication link. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for a master selection process as described herein.

The received code may be executed by processor 404 as it is received, and/or stored in storage device 410, or other non-volatile storage for later execution. In this manner, computer system 400 may obtain application code in the form of a carrier wave.

### EQUIVALENTS, EXTENSIONS, ALTERNATIVES AND MISCELLANEOUS

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for selecting a master node in a multiple node computer system;
comprising:
each node of multiple nodes in the multiple node computer system selecting a timeout value;
each node starting a timer, wherein each timer is set to expire at the selected timeout value of its corresponding node;
the node with the timer that expires earliest broadcasting an election message to the other nodes of the multiple nodes wherein the election message informs the other nodes that the broadcasting node is a candidate for mastership over the multiple node computer system; and
the other nodes responding to the election message, upon receipt thereof wherein, in the absence of a refusal message from one or more of the other nodes, establishing the candidate as master node in the multiple node computer system and wherein the other nodes function as slave nodes therein.

2. The method as recited in claim 1 wherein the slave nodes send to the master node messages to which the master node sends replies wherein, prior to sending the messages, the slave nodes each start timers wherein, upon receipt of the replies, the slave nodes cancel the timer.

3. The method as recited in claim 2 wherein each of the selected timeout values is greater than an interval between synchronizing messages that are exchanged among the nodes within the multiple node computer system.

4. The method as recited in claim 2 further comprising:
upon a slave node's timer expiring prior to the slave node receiving a reply message from the master node to its message, the slave node broadcasting an election message to the other nodes of the multiple node computer system wherein the election message informs the other nodes that the broadcasting node is a candidate for mastership over the multiple node computer system; and
the other nodes responding to the election message, upon receipt thereof wherein, in the absence of a refusal message from one or more of the other nodes, the broadcasting node is established as master node in the multiple node computer system and wherein the other nodes function as slave nodes therein.

5. The method as recited in claim 2 wherein the messages are exchanged between the nodes with a fast message service.

6. The method as recited in claim 5 wherein the fast message service transmits the messages in the order with which they were broadcast.

7. The method as recited in claim 5 wherein the method further comprises, upon the timers of two or more of the nodes expiring and the two or more nodes broadcasting respective election messages to the other nodes of the multiple node computer system:
the other nodes receiving the respective election messages in the order with which they were transmitted over the fast message service;
the other nodes replying with an acceptance message to the respective election message that was received first and with a refusal message to the respective election messages that are received subsequent to receiving the first respective election message; and
establishing the node that transmitted the election message that was received first as master node in the multiple node computer system and wherein the other nodes function as slave nodes therein.

8. The method as recited in claim 1 wherein, upon receiving a refusal message from one or more of the other nodes, the candidate node functions as a slave node of the multiple node computer system.

9. The method as recited in claim 1 wherein selecting a timeout value is performed randomly.

10. The method as recited in claim 1 further comprising:
upon the other nodes receiving the election message from the mastership candidate node and at least one subsequent election message from one or more nodes, which contend for mastership in the multiple node computer system, the other nodes:
responding to the election message with an acceptance reply message; and
responding to the at least one subsequent election message with an refusal reply message;
wherein the mastership candidate node is established as the master node in the multiple node computer system and wherein the one or more contending nodes function as slaves in the multiple node computer system.

11. The method as recited in claim 1 wherein the method is triggered in response to one or more of:
rebooting the master node in the multi-node computer system;
rebooting the multi-node computer system wherein no master node persistence is set;
the master node ceasing to function;
the master node leaving the multi-node computer system;
a application executing in the multi-node computer system requesting selection of a master node in the multi-node computer system; or
one or more nodes of lacking awareness of a master node in the multi-node computer system to which they belong.

12. The method as recited in claim 11 wherein the lacking awareness arises from one or more nodes:
failing to receive one or more messages; or
one or more nodes receiving one or more messages in an other than timely period.

13. A computer readable medium having instructions encoded therewith which, when executed with one or more processors of a computer system, cause the processors to execute the method recited in claim 1.

14. A computer readable medium having instructions encoded therewith which, when executed with one or more processors of a computer system, cause the processors to execute the method recited in claim 2.

15. A computer readable medium having instructions encoded therewith which, when executed with one or more processors of a computer system, cause the processors to execute the method recited in claim 3.

16. A computer readable medium having instructions encoded therewith which, when executed with one or more processors of a computer system, cause the processors to execute the method recited in claim 4.

17. A computer readable medium having instructions encoded therewith which, when executed with one or more processors of a computer system, cause the processors to execute the method recited in claim 5.

18. A computer readable medium having instructions encoded therewith which, when executed with one or more processors of a computer system, cause the processors to execute the method recited in claim 6.

19. A computer readable medium having instructions encoded therewith which, when executed with one or more processors of a computer system, cause the processors to execute the method recited in claim 7.

20. A computer readable medium having instructions encoded therewith which, when executed with one or more processors of a computer system, cause the processors to execute the method recited in claim 8.

21. A computer readable medium having instructions encoded therewith which, when executed with one or more processors of a computer system, cause the processors to execute the method recited in claim 9.

22. A computer readable medium having instructions encoded therewith which, when executed with one or more processors of a computer system, cause the processors to execute the method recited in claim 10.

23. A computer readable medium having instructions encoded therewith which, when executed with one or more processors of a computer system, cause the processors to execute the method recited in claim 11.

24. A computer readable medium having instructions encoded therewith which, when executed with one or more processors of a computer system, cause the processors to execute the method recited in claim 12.
